(19) United States
(12) Patent Application Publication
(10) Pub. No.: US 2018/0088569 A1
(43) Pub. Date: Mar. 29, 2018

(54) OFF-LINE-PROGRAMMING JOG ASSIST DEVICE, JOG ASSIST METHOD, AND RECORDING MEDIUM STORING JOG ASSIST PROGRAM

(71) Applicant: FANUC CORPORATION, YAMANASHI (JP)

(72) Inventor: Tatsuya OUMI, Yamanashi (JP)

(21) Appl. No.: 15/711,473

(22) Filed: Sep. 21, 2017

(30) Foreign Application Priority Data
Sep. 29, 2016 (JP) 2016-191164

(51) Int. Cl. G05B 19/425; G05B 19/19

(52) U.S. Cl. CPC G05B 19/425; G05B 2219/50048; G05B 19/19

(57) ABSTRACT

An off-line-programming jog assist device includes a teaching-point setting unit that sets a teaching point specified by a user on a surface of an object that is disposed in a virtual space and that has a ridgeline; a ridgeline searching unit that searches for a point on the ridgeline in the vicinity of the teaching point; a direction calculating unit that calculates a tangential direction, a principal-normal direction, and a binormal direction at the point on the ridgeline; and a target-coordinate-system calculating unit that calculates a target coordinate system on the basis of the position of the point on the ridgeline, the tangential direction, the principal-normal direction, the binormal direction, and predetermined parameters; and a move-command generating unit that generates a move command so as to cause a tool coordinate system that is set for a robot in the virtual space to coincide with the target coordinate system.

### CROSS-REFERENCE TO RELATED APPLICATIONS

This application is based on Japanese Patent Application No. 2016-191164, filed on Sep. 29, 2016, the entire content of which is incorporated herein by reference.

### FIELD OF THE INVENTION

The present invention relates to an off-line-programming jog assist device, a jog assist method, and a recording medium storing a jog assist program that are suitable for performing a jog operation of a robot in off-line programming.

### BACKGROUND OF THE INVENTION

As a method for performing teaching with respect to a robot that operates along a ridgeline of a workpiece, for arc welding, deburring, etc., there is a known method in which an actual arc-welding robot is operated through a jog operation by using a manual input means that is connected to a robot control device, and the position and the orientation (a target angle and an advance angle) of the arc-welding robot are set for each teaching point (for example, see PCT International Publication No. WO 1997/006473).

### SUMMARY OF THE INVENTION

According to a first aspect, the present invention provides an off-line-programming jog assist device including: a teaching-point setting unit that sets a teaching point specified by a user on a surface of an object that is disposed in a virtual space and that has a ridgeline; a ridgeline searching unit that searches for a point on the ridgeline in the vicinity of the teaching point; a direction calculating unit that calculates a tangential direction, a principal-normal direction, and a binormal direction at the point on the ridgeline; a target-coordinate-system calculating unit that calculates a target coordinate system on the basis of the position of the point on the ridgeline, the tangential direction, the principal-normal direction, the binormal direction, and predetermined parameters; and a move-command generating unit that generates a move command so as to cause a tool coordinate system that is set for a robot in the virtual space to coincide with the target coordinate system.

According to a second aspect, the present invention provides an off-line-programming jog assist method in which a computer executes: a step of setting a teaching point specified by a user on a surface of an object that is disposed in a virtual space and that has a ridgeline; a step of searching for a point on the ridgeline in the vicinity of the teaching point; a step of calculating a tangential direction, a principal-normal direction, and a binormal direction at the point on the ridgeline; a step of calculating a target coordinate system on the basis of the position of the point on the ridgeline, the tangential direction, the principal-normal direction, the binormal direction, and predetermined parameters; and a step of generating a move command so as to cause a tool coordinate system that is set for a robot in the virtual space to coincide with the target coordinate system.

According to a third aspect, the present invention provides an off-line-programming jog assist program for causing a computer to execute: a process of setting a teaching point specified by a user on a surface of an object that is disposed in a virtual space and that has a ridgeline; a process of searching for a point on the ridgeline in the vicinity of the teaching point; a process of calculating a tangential direction, a principal-normal direction, and a binormal direction at the point on the ridgeline; a process of calculating a target coordinate system on the basis of the position of the point on the ridgeline, the tangential direction, the principal-normal direction, the binormal direction, and predetermined parameters; and a process of generating a move command so as to cause a tool coordinate system that is set for a robot in the virtual space to coincide with the target coordinate system.

### BRIEF DESCRIPTION OF THE DRAWINGS

FIG. 1 is a block diagram showing, in outline, the configuration of an off-line-programming jog assist device according to one embodiment of the present invention.

FIG. 2 is a view showing functional blocks of the off-line-programming jog assist device according to the embodiment of the present invention.

FIG. 3 is a flowchart showing processing in the off-line-programming jog assist device according to the embodiment of the present invention.

FIG. 4 is a view for explaining a tool coordinate system and a target coordinate system.

### DESCRIPTION OF EMBODIMENTS

An off-line-programming jog assist device according to one embodiment of the present invention will be described in detail below with reference to the drawings.

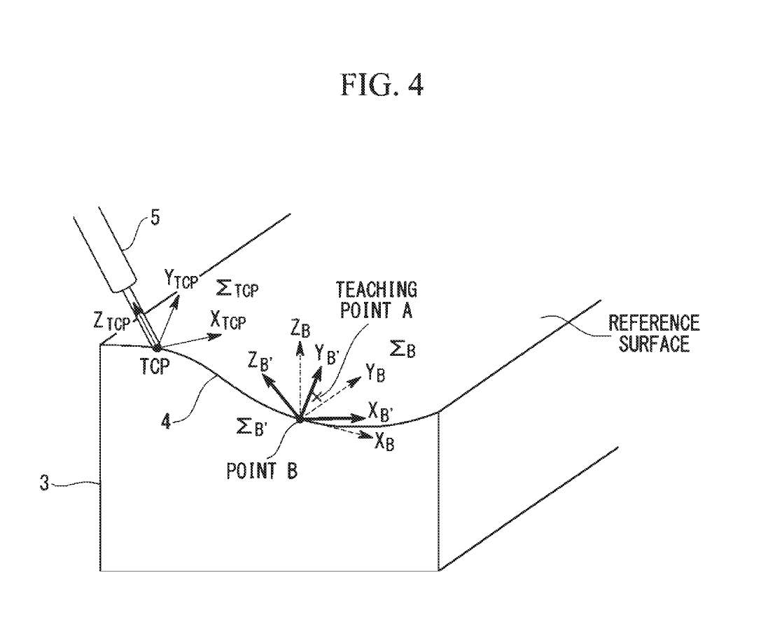

In this embodiment, as shown in FIG. 4, a description will be given of a case in which it is assumed that an object 3 that has a ridgeline 4 and a welding torch 5 that is attached to a hand portion of a robot are disposed as CAD models in a virtual space, and the position and the orientation of the welding torch 5 are taught.

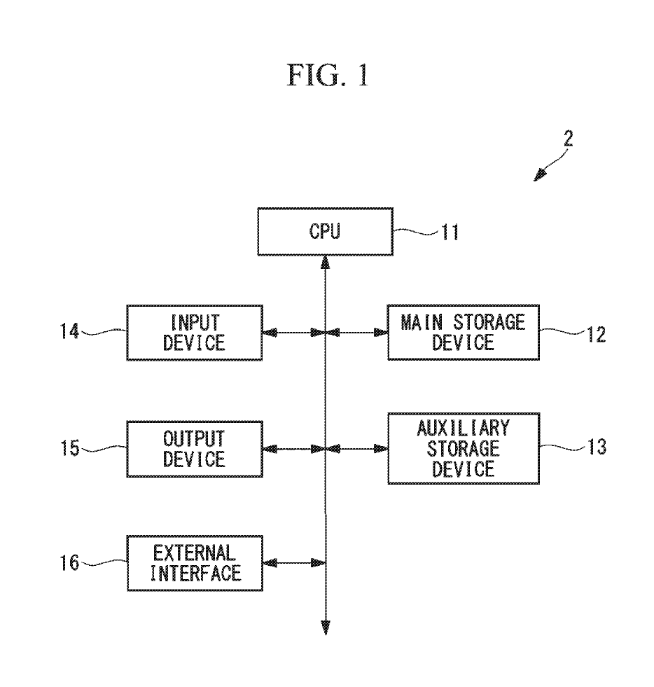

As shown in FIG. 1, an off-line-programming jog assist device 2 of this embodiment is provided with: a CPU (Central Processing Unit) 11; a main storage device 12, such as a ROM (Read Only Memory) and a RAM (Random Access Memory); an auxiliary storage device 13, such as an HDD (Hard Disk Drive); an input device 14, such as a keyboard, a mouse, or a touch panel; an output device 15, such as a monitor; and an external interface 16 that exchanges various types of data with an external device, such as a robot control device. These devices in the off-line-programming jog assist device 2 are connected to each other via a bus. Specifically, the off-line-programming jog assist device 2 of this embodiment is provided with a computer.

The auxiliary storage device 13 stores various programs including a jog assist program of this embodiment, and, the CPU 11 reads a program from the auxiliary storage device 13 onto the main storage device 12, such as a RAM, and executes the program, thereby realizing various types of processing.

Functional blocks of the off-line-programming jog assist device 2, which has the above-described configuration, will be described below with reference to the drawings.

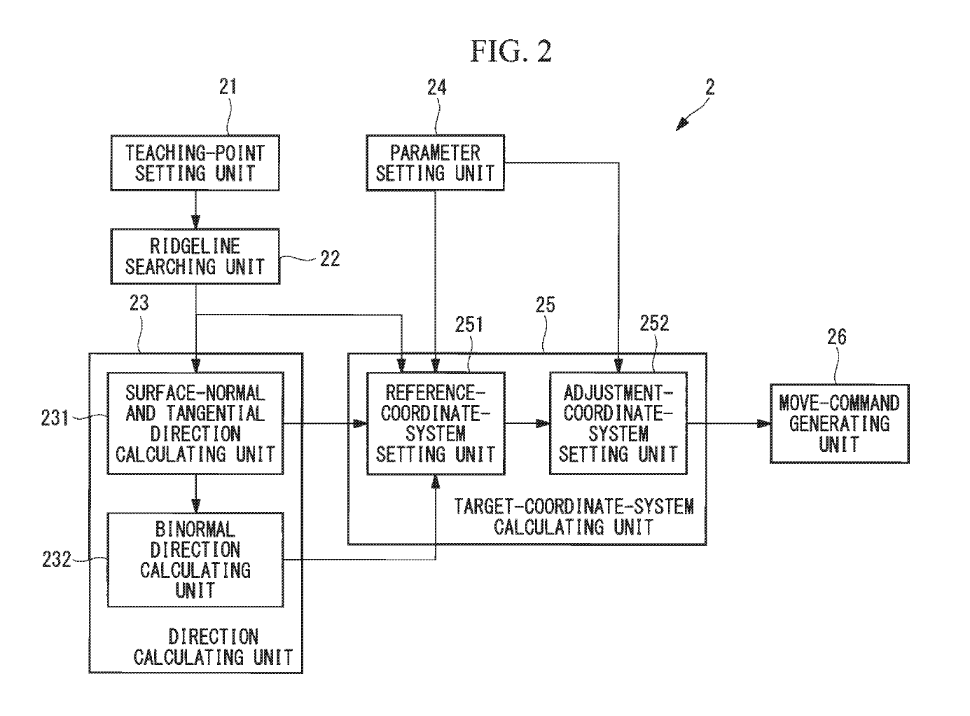

As shown in FIG. 2, the off-line-programming jog assist device 2 is provided with, as functional blocks, a teaching-point setting unit 21, a ridgeline searching unit 22, a direction calculating unit 23, a parameter setting unit 24, a target-coordinate-system calculating unit 25, and a move-command generating unit 26.

The teaching-point setting unit 21 is connected to the ridgeline searching unit 22. The ridgeline searching unit 22 is connected to the direction calculating unit 23 and the target-coordinate-system calculating unit 25. The direction calculating unit 23 is connected to the ridgeline searching unit 22 and the target-coordinate-system calculating unit 25. The parameter setting unit 24 is connected to the target-coordinate-system calculating unit 25. The target-coordinate-system calculating unit 25 is connected to the ridgeline searching unit 22, the direction calculating unit 23, the parameter setting unit 24, and the move-command generating unit 26. The move-command generating unit 26 is connected to the target-coordinate-system calculating unit 25.

The direction calculating unit 23 is provided with a surface-normal and tangential direction calculating unit 231, and a binormal direction calculating unit 232. The target-coordinate-system calculating unit 25 is provided with a reference-coordinate-system setting unit 251 and an adjustment-coordinate-system setting unit 252.

The surface-normal and tangential direction calculating unit 231 is connected to the ridgeline searching unit 22, the binormal direction calculating unit 232, and the reference-coordinate-system setting unit 251. The binormal direction calculating unit 232 is connected to the surface-normal and tangential direction calculating unit 231 and the reference-coordinate-system setting unit 251.

The reference-coordinate-system setting unit 251 is connected to the ridgeline searching unit 22, the parameter setting unit 24, the surface-normal and tangential direction calculating unit 231, the binormal direction calculating unit 232, and the adjustment-coordinate-system setting unit 252. The adjustment-coordinate-system setting unit 252 is connected to the parameter setting unit 24, the reference-coordinate-system setting unit 251, and the move-command generating unit 26.

As shown in FIG. 4, when a user specifies a point on a surface of the object 3, which is disposed in the virtual space, the teaching-point setting unit 21 is configured to set this point as a teaching point A. For example, the user specifies, with a mouse, a point on a surface of a model of the object 3, which is disposed in the virtual space and reproduced on the monitor.

The ridgeline searching unit 22 is configured to search for a point B on a ridgeline 4 in the vicinity of the teaching point A, which is set by the teaching-point setting unit 21. The point B is, for example, a point on the ridgeline 4 that is located at the shortest distance from the teaching point A.

The direction calculating unit 23 is configured to calculate a tangential direction, a surface-normal (principal-normal) direction, and a binormal direction at the point B on the ridgeline 4, which is searched for by the ridgeline searching unit 22.

More specifically, the surface-normal and tangential direction calculating unit 231, which is provided in the direction calculating unit 23, is configured to calculate a tangent vector and a principal-normal vector at the point B on the ridgeline 4. Then, the binormal direction calculating unit 232, which is provided in the direction calculating unit 23, is configured to calculate a binormal vector on the basis of the tangent vector and the principal-normal vector, which are calculated in the surface-normal and tangential direction calculating unit 231.

Referring to FIG. 4, in a reference coordinate system Σ_{B} (X_{B}, Y_{B}, Z_{B}) that is set at the point B and that will be described later, the positive direction of an X_{B} axis indicates the direction of the tangent vector, the positive direction of a Z_{B} axis indicates the direction of the principal-normal vector, and the positive direction of a Y_{B} axis indicates the direction of the binormal vector.

Note that, as vectors orthogonal to the tangent vector and the principal-normal vector, there are two vectors, i.e., a vector directed to a reference surface of the object 3, shown in FIG. 4, and a vector directed to the opposite side from the reference surface; however, in this embodiment, the vector directed to the reference surface is defined as a binormal vector.

The parameter setting unit 24 is configured such that the user can set, in advance, various parameters to be used in the target-coordinate-system calculating unit 25, to be described later.

Specifically, it is possible to set parameters regarding the correspondence relations showing how an X_{TCP} axis, a Y_{TCP} axis, and a Z_{TCP} axis of a tool coordinate system Σ_{TCP}(X_{TCP}, Y_{TCP}, Z_{TCP}) that is set at a distal end of the welding torch 5 are associated with the directions of the tangent vector, the principal-normal vector and the binormal vector at the point B.

Furthermore, the parameter setting unit 24 is configured so as to be able to set angle parameters that are necessary to apply adjustment angles to the reference coordinate system Σ_{B} (X_{B}, Y_{B}, Z_{B}) to set an adjustment coordinate system (target coordinate system) Σ_{B′}(X_{B′}, Y_{B′}, Z_{B′}). Examples of the angle parameters that can be set in the parameter setting unit 24 may be Euler angles or may be roll, pitch, and yaw angles. Alternatively, a target angle and an advance angle in arc welding may also be set therein, and angle parameters can be freely changed according to the use to which a robot is applied.

The parameter setting unit 24 is configured such that various parameters can be input by the user via a GUI (Graphical User Interface) displayed on the monitor provided in the off-line-programming jog assist device 2, for example.

The target-coordinate-system calculating unit 25 is configured to set the target coordinate system at the point B on the basis of: the position coordinates of the point B on the ridgeline 4, which is searched for by the ridgeline searching unit 22; the tangent vector, the principal-normal vector, and the binormal vector, which are calculated by the direction calculating unit 23; and the parameters, which are set by the parameter setting unit 24.

More specifically, the reference-coordinate-system setting unit 251, which is provided in the target-coordinate-system calculating unit 25, is configured to calculate the reference coordinate system Σ_{B}(X_{B}, Y_{B}, Z_{B}) by applying the parameters indicating the correspondence relations between the respective axes and the respective vectors, the parameters being set by the parameter setting unit 24, to the position coordinates of the point B, which is searched for by the ridgeline searching unit 22, and to the tangent vector, the principal-normal vector, and the binormal vector at the point B, which are calculated by the direction calculating unit 23.

In the example shown in FIG. 4, the tangent vector at the point B is made to coincide with the positive direction of the X_{TCP} axis of the tool coordinate system Σ_{TCP}(X_{TCP}, Y_{TCP}, Z_{TCP}), the principal-normal vector thereat is made to coincide with the positive direction of the Z_{TCP} axis of the tool coordinate system Σ_{TCP}(X_{TCP}, Y_{TCP}, Z_{TCP}), and the binormal vector thereat is made to coincide with the positive direction of the Y_{TCP} axis of the tool coordinate system Σ_{TCP}(X_{TCP}, Y_{TCP}, Z_{TCP}); as a result, the reference coordinate system Σ_{B}(X_{B}, Y_{B}, Z_{B}) is set.

The adjustment-coordinate-system setting unit 252, which is provided in the target-coordinate-system calculating unit 25, is configured to set an adjustment coordinate system Σ_{B′}(X_{B′}, Y_{B′}, Z_{B′}) by adjusting the orientation of the reference coordinate system Σ_{B}(X_{B}, Y_{B}, Z_{B}), which is set by the reference-coordinate-system setting unit 251, by the angle parameters, which are set by the parameter setting unit 24.

The move-command generating unit 26 is configured to generate a move command for causing the tool coordinate system Σ_{TCP}(X_{TCP}, Y_{TCP}, Z_{TCP}), which is set at the TCP (Tool Center Point) of the tool, to coincide with the target coordinate system, the adjustment coordinate system Σ_{B′}(X_{B′}, Y_{B′}, Z_{B′}), which is set by the adjustment-coordinate-system setting unit 252 provided in the target-coordinate-system calculating unit 25, serving as the target coordinate system.

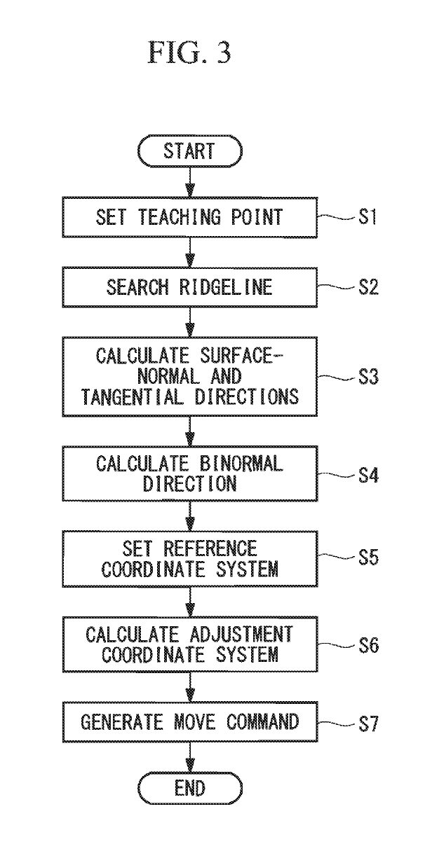

Next, a jog assist method of this embodiment executed in the off-line-programming jog assist device 2, which has the above-described configuration, will be described with reference to FIGS. 2 and 3.

First, in the teaching-point setting unit 21, one point on a surface of the object 3 disposed in the virtual space, the point being specified by the user, is set as the teaching point A (Step S1 in FIG. 3).

Next, in the ridgeline searching unit 22, the point B on the ridgeline 4 in the vicinity of the teaching point A, which is set in the teaching-point setting unit 21, is searched for (Step S2 in FIG. 3).

Then, in the surface-normal and tangential direction calculating unit 231, which is provided in the direction calculating unit 23, the tangent vector and the principal-normal (surface normal) vector at the point B on the ridgeline 4, which is searched for by the ridgeline searching unit 22, are calculated (Step S3 in FIG. 3). Then, in the binormal direction calculating unit 232, which is provided in the direction calculating unit 23, the binormal vector orthogonal to the tangent vector and the principal-normal vector, which are calculated in the surface-normal and tangential direction calculating unit 231, is calculated (Step S4 in FIG. 3).

Next, in the reference-coordinate-system setting unit 251, which is provided in the target-coordinate-system calculating unit 25, the reference coordinate system Σ_{B}(X_{B}, Y_{B}, Z_{B}) is calculated by applying the correspondence relations between the axes and the vectors, which are set in the parameter setting unit 24, to the position coordinates of the point B, which is searched for by the ridgeline searching unit 22, and to the tangent vector, the principal-normal vector, and the binormal vector at the point B, which are calculated by the direction calculating unit 23 (Step S5 in FIG. 3). Next, in the adjustment-coordinate-system setting unit 252, which is provided in the target-coordinate-system calculating unit 25, the orientation of the reference coordinate system Σ_{B}(X_{B}, Y_{B}, Z_{B}), which is set in the reference-coordinate-system setting unit 251, is adjusted by means of the angle parameters, which are set in the parameter setting unit 24, and thus the adjustment coordinate system Σ_{B′}(X_{B′}, Y_{B′}, Z_{B′}) is set as the target coordinate system (Step S6 in FIG. 3).

Finally, in the move-command generating unit 26, a move command is generated so as to cause the tool coordinate system Σ_{TCP}(X_{TCP}, Y_{TCP}, Z_{TCP}), which is set at the TCP of the tool, to coincide with the target coordinate system, the adjustment coordinate system Σ_{B′}(X_{B′}, Y_{B′}, Z_{B′}), which is set in the adjustment-coordinate-system setting unit 252 provided in the target-coordinate-system calculating unit 25, serving as the target coordinate system (Step S7 in FIG. 3).

In this way, with the off-line-programming jog assist device 2 of this embodiment, the user sets the parameters in advance, thereby automatically setting the position and the orientation of the tool at the teaching point; thus, it is not necessary to set the position and the orientation of the tool for each teaching point. As a result, the man hours required to perform teaching, through a jog operation, with respect to a robot in off-line programming can be reduced as much as possible.

Although the embodiment of the present invention has been described above in detail with reference to the drawings, the specific configurations are not limited to the embodiment, and design changes etc. that do not depart from the scope of the present invention are also encompassed.

For example, in the above-described embodiment, although arc welding has been illustrated as an example of the robot application, the present invention is not limited thereto and can be applied to robot applications for movement along a ridgeline of a workpiece for deburring etc.

Furthermore, in the above-described embodiment, although the functions of the off-line-programming jog assist device 2 are implemented by executing the jog assist program, which is software, the present invention is not limited thereto, and the functions of the off-line-programming jog assist device 2 may be implemented in the form of hardware, such as a circuit on a silicon chip.

As a result, the above-described embodiment leads to the following aspects.

According to a first aspect, the present invention provides an off-line-programming jog assist device including: a teaching-point setting unit that sets a teaching point specified by a user, on a surface of an object that is disposed in a virtual space and that has a ridgeline; a ridgeline searching unit that searches for a point on the ridgeline in the vicinity of the teaching point; a direction calculating unit that calculates a tangential direction, a principal-normal direction, and a binormal direction at the point on the ridgeline; a target-coordinate-system calculating unit that calculates a target coordinate system on the basis of the position of the point on the ridgeline, the tangential direction, the principal-normal direction, the binormal direction, and predetermined parameters; and a move-command generating unit that generates a move command so as to cause a tool coordinate system that is set for a robot in the virtual space to coincide with the target coordinate system.

According to the off-line-programming jog assist device of this aspect, the teaching-point setting unit specifies a teaching point specified by the user, on a surface of an object that is disposed in a virtual space and that has a ridgeline, and the ridgeline searching unit searches for a point on the ridgeline in the vicinity of the teaching point. Then, the direction calculating unit calculates a tangential direction, a principal-normal direction, and a binormal direction at the point on the ridgeline. Then, the target-coordinate-system calculating unit calculates a target coordinate system on the basis of the position of the point on the ridgeline, the tangential direction, the principal-normal direction, the binormal direction, and predetermined parameters. The move-command generating unit generates a move command so as to cause a tool coordinate system that is set for a robot in the virtual space to coincide with the target coordinate system.

By doing so, because the position and the orientation of the target coordinate system are automatically set according to the position on the ridgeline, the man hours required to perform teaching, through a jog operation, in off-line programming can be reduced as much as possible.

In the above-described off-line-programming jog assist device, the parameters may include angles for adjusting the orientation of the target coordinate system.

Accordingly, the orientation of the target coordinate system can be adjusted according to the angles set in advance as the parameters.

According to a second aspect, the present invention provides an off-line-programming jog assist method in which a computer executes: a step of setting a teaching point specified by a user, on a surface of an object that is disposed in a virtual space and that has a ridgeline; a step of searching for a point on the ridgeline in the vicinity of the teaching point; a step of calculating a tangential direction, a principal-normal direction, and a binormal direction at the point on the ridgeline; a step of calculating a target coordinate system on the basis of the position of the point on the ridgeline, the tangential direction, the principal-normal direction, the binormal direction, and predetermined parameters; and a step of generating a move command so as to cause a tool coordinate system that is set for a robot in the virtual space to coincide with the target coordinate system.

According to a third aspect, the present invention provides an off-line-programming jog assist program for causing a computer to execute: a process of setting a teaching point specified by a user, on a surface of an object that is disposed in a virtual space and that has a ridgeline; a process of searching for a point on the ridgeline in the vicinity of the teaching point; a process of calculating a tangential direction, a principal-normal direction, and a binormal direction at the point on the ridgeline; a process of calculating a target coordinate system on the basis of the position of the point on the ridgeline, the tangential direction, the principal-normal direction, the binormal direction, and predetermined parameters; and a process of generating a move command so as to cause a tool coordinate system that is set for a robot in the virtual space to coincide with the target coordinate system.

According to the present invention, an advantageous effect is afforded in that, in off-line programming, the man hours required to teach the position and the orientation of a robot through a jog operation can be reduced as much as possible.

1. An off-line-programming jog assist device comprising:
a teaching-point setting unit that sets a teaching point specified by a user on a surface of an object that is disposed in a virtual space and that has a ridgeline;
a ridgeline searching unit that searches for a point on the ridgeline in the vicinity of the teaching point;
a direction calculating unit that calculates a tangential direction, a principal-normal direction, and a binormal direction at the point on the ridgeline;
a target-coordinate-system calculating unit that calculates a target coordinate system based on the position of the point on the ridgeline, the tangential direction, the principal-normal direction, the binormal direction, and predetermined parameters; and
a move-command generating unit that generates a move command so as to cause a tool coordinate system that is set for a robot in the virtual space to coincide with the target coordinate system.

2. An off-line-programming jog assist device according to claim 1, wherein the predetermined parameters include angles for adjusting the orientation of the target coordinate system.

3. An off-line-programming jog assist method in which a computer executes:
a step of setting a teaching point specified by a user on a surface of an object that is disposed in a virtual space and that has a ridgeline;
a step of searching for a point on the ridgeline in the vicinity of the teaching point;
a step of calculating a tangential direction, a principal-normal direction, and a binormal direction at the point on the ridgeline;
a step of calculating a target coordinate system based on the position of the point on the ridgeline, the tangential direction, the principal-normal direction, the binormal direction, and predetermined parameters; and
a step of generating a move command so as to cause a tool coordinate system that is set for a robot in the virtual space to coincide with the target coordinate system.

4. A non-transitory recording medium storing an off-line-programming jog assist program for causing a computer to execute:
a process of setting a teaching point specified by a user on a surface of an object that is disposed in a virtual space and that has a ridgeline;
a process of searching for a point on the ridgeline in the vicinity of the teaching point;
a process of calculating a tangential direction, a principal-normal direction, and a binormal direction at the point on the ridgeline;
a process of calculating a target coordinate system based on the position of the point on the ridgeline, the tangential direction, the principal-normal direction, the binormal direction, and predetermined parameters; and
a process of generating a move command so as to cause a tool coordinate system that is set for a robot in the virtual space to coincide with the target coordinate system.
